(19) United States
(12) Patent Application Publication
(10) Pub. No.: US 2012/0296539 A1
(43) Pub. Date: Nov. 22, 2012

(54) DRIVER ASSISTANCE SYSTEM

(75) Inventors: Troy Otis Cooprider, White Lake, MI (US); Srinivas Tummala, Auburn Hills, MI (US); Faroog Ibrahim, Dearborn Heights, MI (US)

(73) Assignee: TK Holdings Inc.

(21) Appl. No.: 13/427,789

(22) Filed: Mar. 22, 2012

Related U.S. Application Data
(60) Provisional application No. 61/466,860, filed on Mar. 23, 2011.
(60) Provisional application No. 61/466,869, filed on Mar. 23, 2011.

(51) Int. Cl. G06F 7/00; G01C 21/34

(52) U.S. Cl. 701/70; 701/410; 701/1; 701/468

(57) ABSTRACT

A system and method of assisting a driver of a vehicle by providing driver and vehicle feedback control signals is disclosed herein. The system and method includes receiving location data of the vehicle from a GPS unit, receiving the location data of the vehicle and retrieving navigation characteristics relevant to the location data using a processing circuit, generating a most probable future path for the vehicle and determining a location of at least one navigation characteristic with respect to the most probable future path and the vehicle, generating vehicle data at least one vehicle sensor, and transmitting a control signal to a vehicle control area network to warn the driver of an upcoming navigation characteristic on the most probable path.

### CROSS-REFERENCE TO RELATED PATENT APPLICATIONS

This application claims priority from Provisional Application U.S. Application 61/466,860, filed Mar. 23, 2011, incorporated herein by reference in its entirety. This application also claims priority from Provisional Application U.S. Application 61/466,869, filed Mar. 23, 2011, incorporated herein by reference in its entirety.

### BACKGROUND OF THE INVENTION

Driver assistance systems are becoming more and more prevalent in vehicles. Driver assistance systems can help a driver deal with an upcoming road hazard condition, whether it be an upcoming acute curve in the road or an accident that has occurred in a portion of the road in which the driver is driving towards.

Navigation warning systems alert the driver when various driving events on a segment of road the vehicle is traveling on are encountered. Optical sensors are the dominant technology to detect driving events. Color cameras are typically used to help detect a traffic sign on the roadside and to distinguish between different types of traffic signs, and a classification algorithm is typically used to recognize the printed speed on the sign.

Like most vision systems, optical sensor based zone warning inevitably suffers from adverse illumination and weather conditions when the assistance is needed most. A method of detecting speed or no-passing zone warning using visual sensors suffers from several limitations. The visual sensors can fail to detect signs in complex environment (e.g., downtown streets). The visual sensors can also fail to detect signs because of different sign shape and location. The visual sensors can also incorrectly recognize speeds because of misclassification at high speeds. The visual sensors can also suffer from degraded detection/recognition at night, in rain or snow, when facing low angle sunlight (e.g., at dawn or dusk).

### SUMMARY OF THE INVENTION

According to an exemplary embodiment, a driver assistance system includes a map database comprising a map database comprising navigation characteristics related to road locations, a GPS unit that receives location data of the vehicle, a map matching module configured to receive the location data of the vehicle and retrieve navigation characteristics relevant to the location data using a processing circuit, a prediction module configured to generate a most probable future path for the vehicle and to determine a location of at least one navigation characteristic with respect to the most probable future path and the vehicle, at least one vehicle sensor unit configured to generate vehicle data, and a warning module configured to transmit a control signal to a vehicle control area network to warn the driver of an upcoming navigation characteristic on the most probable path.

According to yet another exemplary embodiment, a driver assistance method includes receiving location data of the vehicle from a GPS unit, receiving the location data of the vehicle and retrieving navigation characteristics relevant to the location data using a processing circuit, generating a most probable future path for the vehicle and determining a location of at least one navigation characteristic with respect to the most probable future path and the vehicle, generating vehicle data at least one vehicle sensor, and transmitting a control signal to a vehicle control area network to warn the driver of an upcoming navigation characteristic on the most probable path.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic diagram of a vehicle control area network;

FIG. 2 is a schematic diagram of various vehicle system components and a general driver assistance system;

FIG. 3 is a schematic diagram of a driver assistance system;

FIG. 4 depicts a graphical representation of a generated path tree;

FIG. 5 depicts a graphical representation of a future most probable path determination;

FIG. 6 is a general flow chart of a method for producing a control signal;

FIG. 7 is a flow chart of a method for detecting intersection data and producing a control signal in response to the intersection data;

FIG. 8 is a flow chart of a method for detecting slope of a future most probable path and producing a control signal based on the detected slope; and

FIG. 9 is a flow chart of a method for generating a lane change control signal.

### DETAILED DESCRIPTION OF THE PREFERRED EMBODIMENTS

Before describing in detail the particular improved system and method, it should be observed that the several disclosed embodiments include, but are not limited to a novel structural combination of conventional data and/or signal processing components and communications circuits, and not in the particular detailed configurations thereof. Accordingly, the structure, methods, functions, control and arrangement of conventional components and circuits have, for the most part, been illustrated in the drawings by readily understandable block representations and schematic diagrams, in order not to obscure the disclosure with structural details which will be readily apparent to those skilled in the art, having the benefit of the description herein. Further, the disclosed embodiments are not limited to the particular embodiments depicted in the exemplary diagrams, but should be construed in accordance with the language in the claims.

In general, according to various exemplary embodiments, a driver assistance system includes a digital map system, vehicle sensor input, vision system input, location input, such as global positioning system (GPS) input, and various driver assistance modules used to make vehicle related determinations based on driver assistance system input. The various driver assistance modules may be used to provide indicators or warnings to a vehicle passenger or may be used to send a control signal to a vehicle system component such as a vehicle engine control unit, or a vehicle steering control unit, for example, by communicating a control signal through a vehicle control area network (CAN).

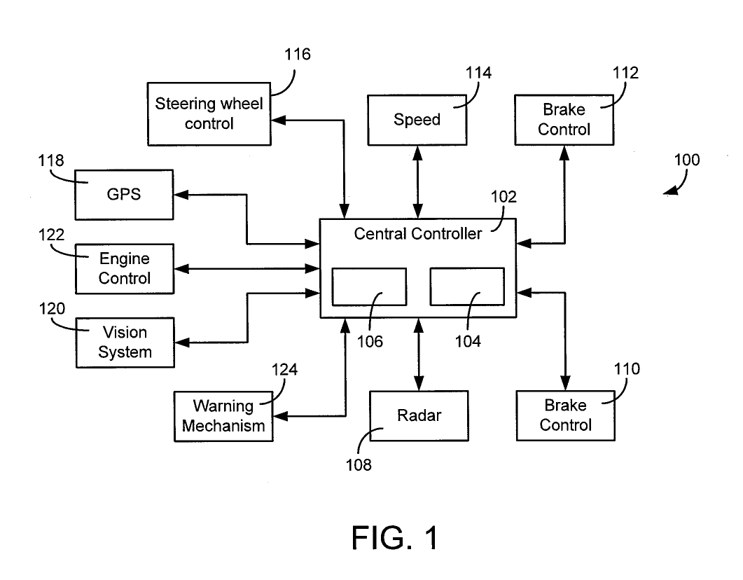

Referring to FIG. 1, a block diagram of a vehicle communication network 100 is shown, according to an exemplary embodiment. Vehicle communication network 100 is located within a vehicle body and allows various vehicle sensors including a radar sensor 108, a speed sensor and/or accelerometer 114, a vehicle vision system 120 which may include a stereovision camera and/or a monovision camera. In addition, communication network 100 receives vehicle location data from GPS module 118. Furthermore, communication network 100 communicates with various vehicle control modules including brake control modules 110 and 112, steering wheel control module 116, engine control module 122, and warning mechanism module 124, for example. Central controller 102 includes at least one memory 104 and at least one processing unit 106. According to one exemplary embodiment vehicle communication network 100 is a control area network (CAN) communication system and prioritizes communications in the network using a CAN bus.

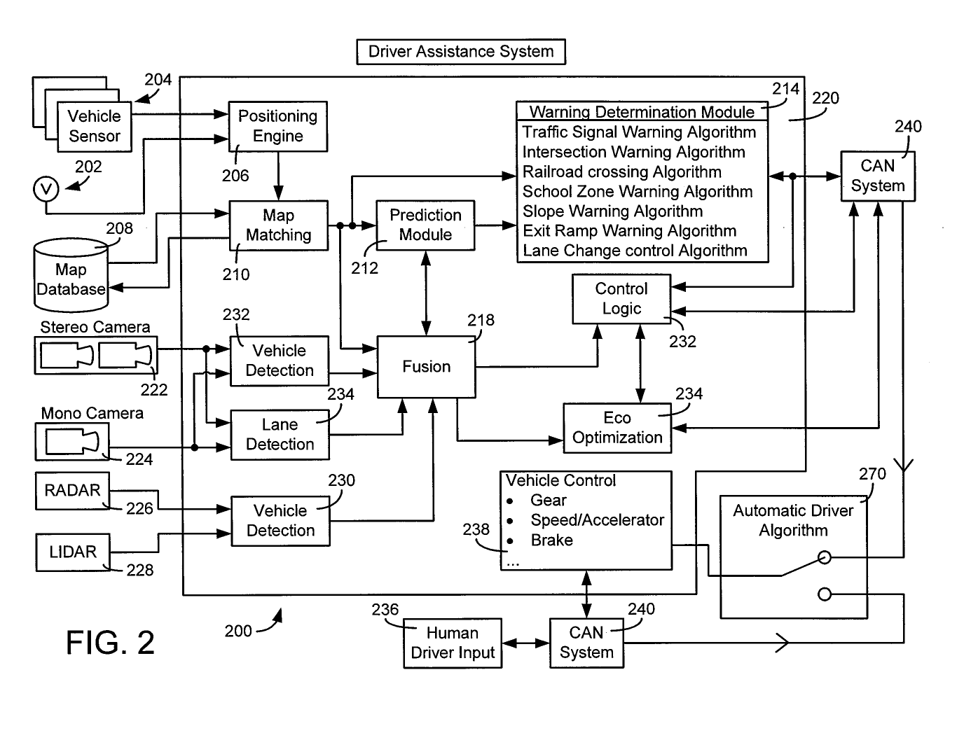

Referring now to FIG. 2, driver assistance system 220 is stored in the memory 104 of central controller 102 according to one embodiment. Driver assistance system 220 includes a map matching module 210. The map matching module 201 includes a map matching algorithm that receives vehicle location data (e.g., latitude, longitude, elevation, etc.) from the GPS unit 202. According to one embodiment, the vehicle location data is enhanced and made more accurate by combining the GPS vehicle location data with vehicle sensor data from at least one vehicle sensor 204 at a positioning engine 206.

According to one exemplary embodiment, vehicle sensor data such as vision data, speed sensor data, and yaw rate data can be combined with GPS data at positioning engine 206 to reduce the set of coordinates that the vehicle may be located to improve the accuracy of the location data. For example, cameras 222 and 224 my be included in vehicle sensors 204 and positioning engine 206 may receive vision data from a camera 222, 224 that has been processed by a lane detection algorithm. According to one embodiment, the lane detection software can modify the received GPS data to indicate that the vehicle is located in a specific lane rather than a general path or road. In addition, other vehicle sensor data such as vision data, speed data, yaw rate data, etc. can be used to further supplement the GPS location data to improve the accuracy of the vehicle location.

Driver assistance system 220 also includes a map database 208 which includes navigation characteristics associated with pathways and roadways that may be traveled on by a vehicle. According to one embodiment, the map database includes data not included in the GPS location data such as road elevations, road slopes, degrees of curvature of various road segments, the location of intersections, the location of stop signs, the location of traffic lights, no passing zone locations, yield sign locations, speed limits at various road locations, and various other navigation characteristics, for example.

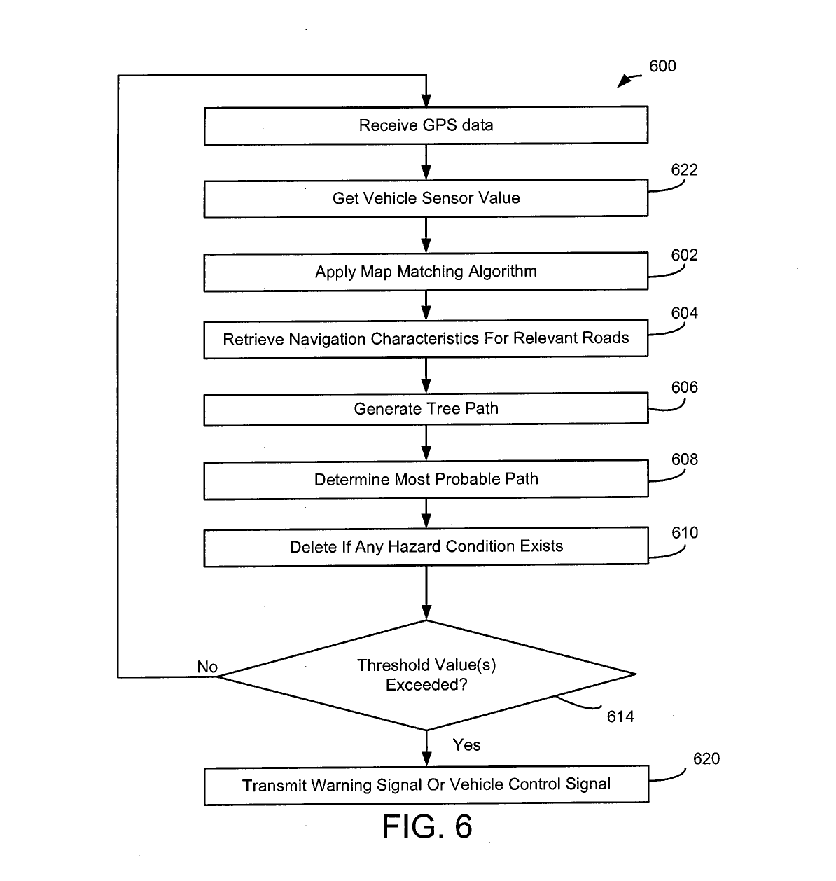

According to one exemplary embodiment, once the positioning engine 206 has determined an enhanced location of the vehicle, the enhanced vehicle location is forwarded to map matching module 210. The map matching algorithm uses the enhanced location of the vehicle from positioning engine 206 or raw location data from the GPS 202 to extract all navigation characteristics associated with the vehicle location. The navigation characteristics extracted from map database 208 may be used for a variety of application algorithms to add to or enhance a vehicle's active or passive electronic safety systems. The application algorithms may be executed alone (i.e., only used with the map data). Several application algorithms are shown in warning detection module 214 including a traffic signal warning algorithm, an intersection warning algorithm, a railroad crossing algorithm, a school zone warning algorithm, a slope warning algorithm, an exit ramp warning algorithm, and a lane change control algorithm. According to some embodiments, each algorithm has various thresholds that are monitored to determine if a control signal is monitored. In some cases multiple algorithms are used to determine of a control signal should be transmitted. Furthermore, several algorithms are shown in flow chart form in FIG. 6-9. These application algorithms may also be executed in connection with a variety of vehicle sensors such as RADAR 226, LIDAR 228, monocular vision 224, stereo vision 224, and various other vehicle sensors 204 to add further functionality. Furthermore, control logic module 232 can include further algorithms to determine how various sensor inputs will cause CAN connected vehicle modules to actuate according to a control signal.

According to one exemplary embodiment, the application algorithms may be used to inform the driver directly via human machine interface (HMI) indicators (e.g., audible indicators, visual indicators, tactile indicators) or a combination of HMI indicators. For example, an audible indicator may alert a driver with a audible sound or message in the case that the speed limit warning algorithm determines the vehicle speed is above a speed limit or is about to exceed a speed limit threshold. In a similar manner, visual indicators may use a display such as an LCD screen or LED light to indicate a warning message and tactile indicators may use a vibration element in a vehicle steering wheel, for example, to alert the driver to a warning message output from the warning determination module 214. Furthermore, the application algorithms may also be provided to a vehicle control module 238 to send a control signal to various vehicle actuators 110, 112, 116, and 122 for example, to directly change how the vehicle operates without human intervention. Additionally, a vehicle driver may be able to decide if they would like to allow vehicle control module 238 to automatically control vehicle modules or not based on the position of switch 270.

In one embodiment of the present disclosure, the driver assistance system 220 is used to provide an intersection warning, such as an intersection warning that is produced when no traffic signal is present in the vicinity of the intersection or a school zone warning for the driver of the vehicle to be aware of an upcoming school zone. According to some embodiments, when a current or predicted vehicle speed is above a threshold speed and the vehicle is a predetermined distance from a school zone on the road the vehicle is traveling on or is predicted to travel on, the warning determination module 214 sends a control signal to CAN system 240 to convey a warning indication to driver of the vehicle via an HMI. In some embodiments, the threshold speed is the stored speed limit in the school zone. According to one exemplary embodiment, the HMI warning is based on known intersections, railroad crossings, school zones, road elevation levels, road lanes, and traffic signal coordinates stored in map database 208 for various geographic locations and provides reliable warnings in all illumination and environmental conditions.

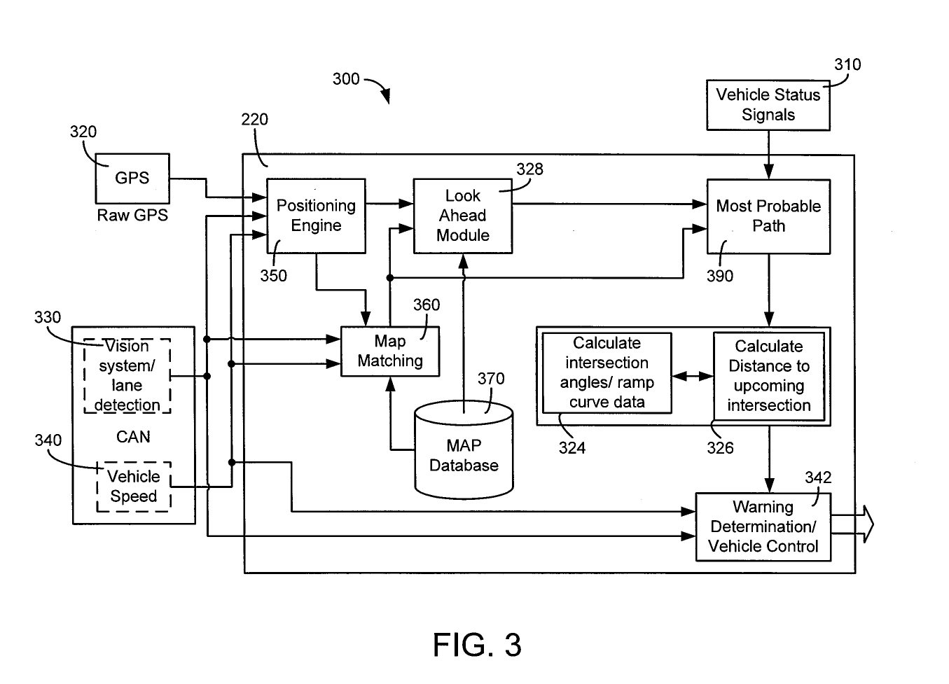

According to one embodiment as shown in FIG. 3, GPS unit 320 provides the current vehicle location to positioning engine or dead reckoning module 350. Module 350 also receives the vehicle speed from sensor 340, if available, the yaw rate of the vehicle from angular rate sensors, if available, and acceleration sensors (accelerometers, not shown), if available, at positioning engine 350 in order to calculate position with better accuracy and produce a higher update rate for map matching module 360, look ahead module 328, and most probable path build 390.

The resulting fused position map from module 350 allows the driver assistance system 220 to predict vehicle position points for more accurate vehicle route data. The GPS and inertial fusion has the benefits of: 1) helping to eliminate GPS multipath and loss of signal in urban canyons, 2) providing significantly better dead reckoning when GPS signal is temporarily unavailable, especially while maneuvering, 3) providing mutual validation between GPS and inertial sensors, and 4) allows the accurate measurement of instantaneous host vehicle behavior due to high sample rate and relative accuracy of the inertial sensors 330, 340. By way of example, the driver assistance system 220 can handle GPS update rates of 5 Hz or greater.

Referring again to FIG. 3, map matching data produced at map matching module 360, provides an output location of a vehicle with respect to a road and navigation characteristics associated with the road. In addition, the stereo vision or monocular vision system provides the forward looking image of the road environment. Such vision system data may be provided directly to map matching module 360 or may be provided at a later step from sensor module 310, for example. A lane detection and tracking algorithm using the stereo vision or monocular vision system calculates host lane position and lane horizontal curvature. The stereo vision system can also calculate a 3D lane profile including vertical curvature, incline/decline angle, and bank angle information. These calculations may be performed at map matching module 360 or may alternatively be performed at various other modules including look ahead module 328, probable path module 390, curvature calculation module 326, or prediction module 212, fusion module 218, control logic module 232 or warning determination module 214, for example.

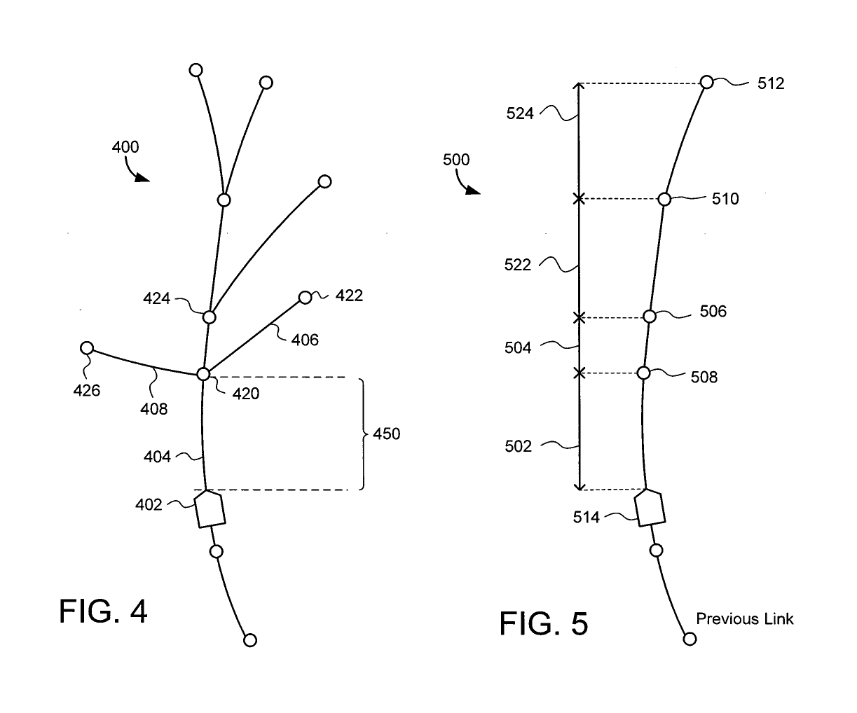

According to one embodiment, prediction module 200 as shown in FIG. 2 look ahead module 328 and probable path module 390 as shown in more detailed FIG. 3. Accordingly, prediction module 200 receives the output of map matching module 210 to generate a path tree 400 comprising a set of forward paths or roads the vehicle 402 can take such as the path between node 420 and node 426 and the current path the vehicle 402 is on as shown in FIG. 4.

Once path tree 400 has been generated, a most probable future path 500 of the vehicle 514 is generated based on the generated path tree, the vehicle data, and the navigation characteristics. In some embodiments, the look ahead module 328 organizes the links in a hierarchical fashion, providing quick access to link features important in path prediction, such as intersecting angles and travel direction.

Details of output of the map matching unit 360 that are provided to the most probable path building unit 390 according to one or more embodiments is described below. The map matching unit 360 matches the GPS-processed position of the vehicle output by the GPS processing unit 350 (which takes into account the inertial sensor data as provided by the sensors 330, 340) to a position on a map in single path and branching road geometry scenarios. In this way, map matching unit 360 provides navigation characteristics, as obtained from the map database 370 to various locations relevant to a vehicle. According to one example, a GPS position is used as an input to a look up table or software algorithm which is used to retrieve navigation characteristics stored in map database 370.

Furthermore, the map matching unit 360 finds the position on the map that is closest to the corrected GPS position provided by module 350, whereby this filtering to find the closest map position using an error vector based on the last time epoch. GPS heading angle and history weights can used by the map matching unit 360 in some embodiments to eliminate irrelevant road links. Map matching as performed by the map matching unit 360 can also utilize information regarding the vehicle's intention (e.g., it's destination), if available, and also the vehicle trajectory. In some embodiments, map matching can be performed by reducing history weight near branching (e.g., a first road intersection with a second road), and by keeping connectivity alive for a few seconds after branching.

Details of the operation of the most probable path unit 390 according to one or more embodiments is described below. The most probable path unit 390 uses the map-matched position as output by the map matching unit 360 as a reference to look ahead of the host vehicle position, extracts the possible road links, and constructs a MPP (Most Probable Path) from the extracted road links. The MPP construction can be affected by the host vehicle speed. Also, angles between the connected branches making up the MPP are computed and are used with other attributes to determine the ‘n’ Most Probable Paths. A path list is then constructed using the ‘n’ MPPs, whereby vehicle status signals as output by the vehicle status signals unit 310 can be used in the selection of the MPPs. Further, a vehicle imaging system can also be utilized in some embodiments to assist in the selection of the MPPs.

FIG. 4 is a diagrammatic representation of the n MPPs that can be output by the most probable path of a vehicle 402, as shown by way of path tree 400 with the various possible paths shown as branches of the tree 400. For example, the path between nodes 420 and 426 as well as the path between 420 and 422 are both possible future paths while subsection 450 between the vehicle location 402 and node 420 is the path tree root. According to one exemplary embodiment the various nodes on the generated path tree 400 are associated with navigation characteristics retrieved from the map database 370 such as road curve data, intersection data, speed limit data, and no passing zone data that may be used to determine if a control signal should be transmitted from the warning determination module 214 or the vehicle control module 238. In addition, map database 370 may be used at map matching module 360 to identify certain nodes as entrances to an exit ramp. For example, the road segment between node 420 and node 422 may be an exit ramp with associated attributes such as ramp curve, speed limit, and whether there is a stop sign or traffic signal at the end of the exit ramp at node 422.

As shown in FIG. 3, the MPP intersection angle/ramp curve calculation unit 324 and distance calculation unit 326 also can be made on one or more of the n MPPs output by the most probable path unit 390. Time and distance calculations can be performed on one or more of the MPPs output by the most probable path unit 390. In some embodiments, time and distance are calculated using vehicle speed and intermodal distances 502, 504, 522, and 524 as shown in FIG. 5 on a determined MPP 500. For example, if the angle between the road segments 420 to 422 and 420 to 424 is a 90 degree angle, and the angle between road segments 420 to 422 and 420 to 426 is 180 degrees, intersection angle unit 324 may determine that node 420 is located at an intersection.

Furthermore, if vehicle 514 is traveling at a speed of 70 m.p.h. and based on distance 502, time and distance calculation module 326 will be able to determine how long it will take for vehicle 514 to enter zone 504. According to one example if the speed of the vehicle is above the speed threshold and the time until a vehicle reaches a zone is under a time threshold, warning determination module 342 will send a control signal to at least one of an HMI indicator or a vehicle module. Similar calculations may be undertake to warn a driver or control a vehicle module if the zone is a no passing zone. However, in such a case the threshold value would be a threshold distance between the vehicle 514 and a road lane, according to one embodiment.

In addition the control signal may communicate a required deceleration (in the case of a speed zone warning) or steering wheel angle of rotation (in the case of a no passing zone warning) so to bring the determined threshold violation under the threshold value. This required deceleration may be provided to a break control module 112 or engine control module 122, for example, to remove the determined threat. In addition, the threat assessment unit 342 can determine a curvature point of interest and a threat associated therewith, whereby each threat may result in the output of a warning to a vehicle operator, wherein the warning is emitted from an HMI, according to one embodiment.

Furthermore, warning determination module 214 may transmit a control signal to an HMI to convey a warning to a vehicle passenger if one of several thresholds is exceeded. Each algorithm included in warning determination module 214 may have one or more thresholds that are monitored. For example, if the current vehicle speed is over the Department of Transportation (DOT) recommended safe speed for the current road curvature and bank angle as determined by a curve speed warning algorithm, or over the posted warning speed of this curve or if a predicted future vehicle speed is over the DOT recommended safe speed for the upcoming lane curvature and bank angle (or over the posted warning speed of this upcoming curve) that the host vehicle is about to enter in a predefined time threshold (e.g., 10 seconds), a control signal may be transmitted from module 214 to a CAN system 240 to be provided to an HMI.

Additionally, the algorithms depicted in warning control module 214 may use various vehicle data collected by vehicle sensors 204 including camera and radar input to calculate the distance and time to an upcoming curve, which, together with the targeted speed, can be provided to the an automatic control module 232 to produce a vehicle control signal at vehicle control module 238 to automatically adjust vehicle speed/deceleration for optimal fuel efficiency without human intervention. Such automatic adjustments may be transmitted as control signals from vehicle control module 238 and provided to a CAN system 240 which distributes the control signal to an appropriate vehicle module such as an engine control module 122 or a brake control module 110, 112.

Based on the road path information as provided by the GPS 202 and the most probable future path as determined by the prediction module 212, the driver assistance system 220 can accurately inform the operator of the vehicle 105 with suitable lead time about an upcoming road condition that may pose a hazard. For example, if the host vehicle 514 enters a speed zone at a speed that exceeds the speed for that zone, then the vehicle will be in violation of an ordinance or may be driving in an unsafe manner. The driver assistance system 220, according to an embodiment of the invention, can warn the driver if the vehicle is moving too fast, whereby the driver assistance system can provide warnings through a HMI prior to entering a speed zone or no passing zone thereby improving on previous warning systems and methods.

Referring to FIG. 6, a general flow chart of a method for producing a curve related control signal is disclosed. Process 600 may be carried out by several different driver assistance system embodiments 200 or 300 and may be a computer program stored in the memory 104 of central controller 104 and executed by at least one processor 106 in central controller 102. Process 600 is merely exemplary and may include additional steps or may not include one or more steps displayed in FIG. 6. According to one exemplary embodiment, at step 602 driver assistance system 220 receives raw GPS data from GPS unit 202. According to one embodiment, this raw GPS data may be enhanced at positioning engine 206 or dead reckoning module 350, for example. As stated previously, the positioning engine improves the accuracy of raw GPS data provided by GPS unit 202 using vehicle sensor data 204 received at step 622 including data from camera units 222 and 224 as well as from other sensors such as an accelerometer, a vehicle speed sensor 340, or a vision system/lane detection software sensor 330.

Once vehicle location data or enhanced vehicle data is determined at step 602, the vehicle location data, which may comprise a set of coordinates, such as longitude and latitude, is provided to a map matching algorithm stored in map matching module 210 for example. According to one embodiment, the map matching algorithm uses the vehicle position coordinates as a reference to look up navigation characteristics associated with the position coordinates in map database 208. For example, a given coordinate may have an associated elevation above sea level, slope value, road curve measurement, lane data, stop sign presence, no passing zone presence, or speed limit for example. Once step 604 generates a series of relevant location coordinates within a road that are associated with various navigation characteristics, this data is provided to prediction module 212 to generate a path tree at step 606 and a most probable path at step 608. According to one embodiment the most probable path is segmented into a series of nodes, each of which are may be associated with a speed zone and/or a no passing zone as determined by navigation characteristics retrieved from map database 208. According to another embodiment, prediction module 212 may calculate time and distance data for future nodes 510, 512 on the most probable path 500 at step 612 based on vehicle speed and/or lane detection data received at step 610.

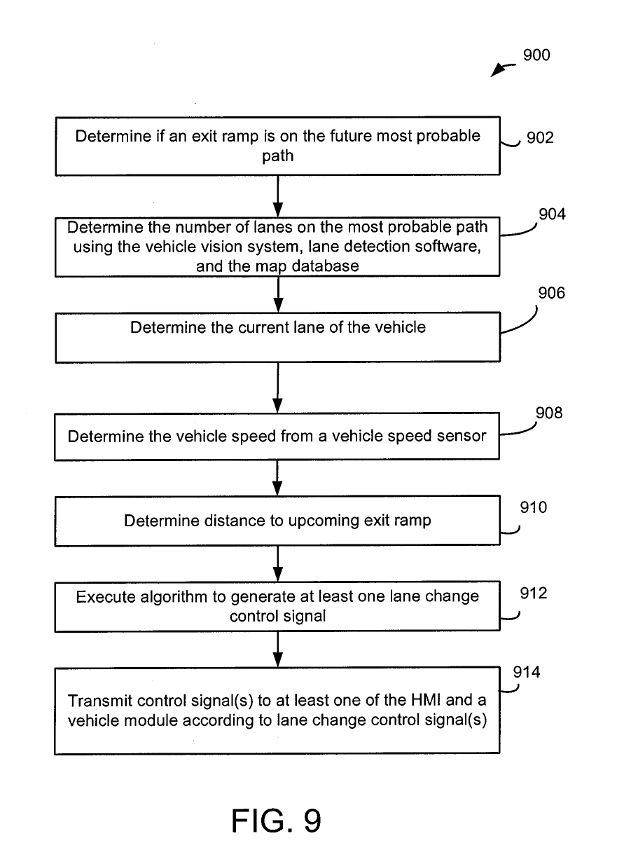

The most probable path and associated navigation characteristics such as intersection locations, exit ramp locations, slope data, or school zones, for example, may then be provided to several other driver assistance modules 218, 232, 234, and 214 for further calculations or processing. According to one embodiment, the most probable path and exit ramp locations are transmitted to warning determination module 214 and entered as input to an exit ramp warning algorithm. FIG. 9 depicts one exemplary embodiment of a process carried out by an exit ramp warning algorithm. The zone warning algorithm will analyze the most probable path data and compare the vehicles speed or lane data with a threshold value associated with a most probable path node 506, 508, 510, and 512, for example.

At step 614, process 600 determines if at least one or more thresholds for a given node have been exceeded. According to one embodiment, if a threshold value has been exceeded warning determination module 214 provides a control signal to CAN system 240, which in turn actuates an HMI to provide a warning or other indication to a vehicle passenger that a dangerous condition is approaching along the most probable path at step 620. Furthermore, step 620 may take place at control logic module 232, eco optimization module 234, or vehicle control module 238 with additional algorithms providing various threshold determinations. For example, vehicle control module 238 may receive the most probable path data from prediction module 212 and determine based on a gear algorithm or braking algorithm whether to actuate a gear control module 116 or brake module 110, 112 by providing a control signal to CAN system 240.

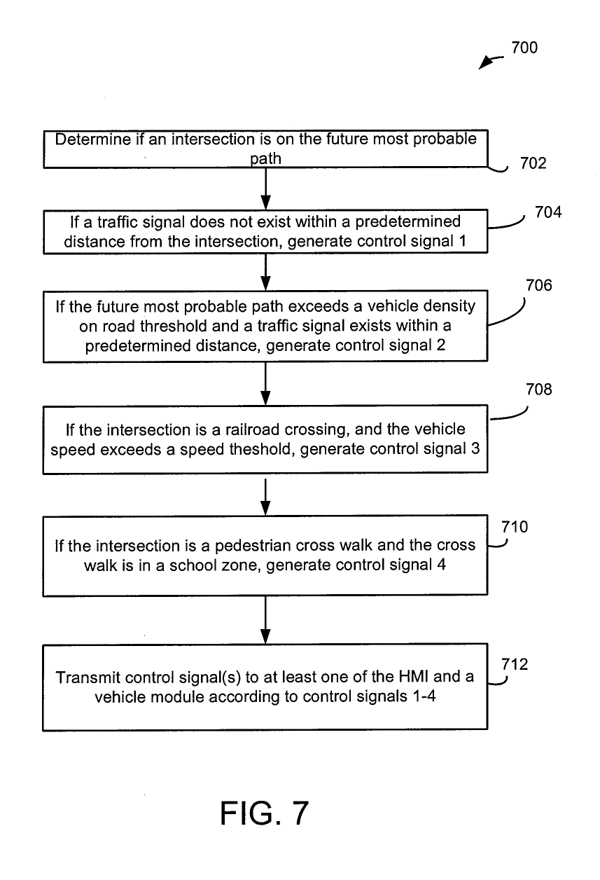

Referring to FIG. 7-FIG. 9, process carried out by various application algorithms stored in warning determination module 214 are shown. For example, with respect to FIG. 7, portions of the intersection warning algorithm, traffic signal warning algorithm, railroad crossing algorithm, and school zone warning algorithms are implemented to produce one or several control signals.

The combination of digital map, GPS technologies and algorithms used in FIG. 7 allow for advance warnings of intersections, railroad crossing, school zones, and pedestrian cross walks. Advance knowledge of these scenarios is beneficial to drivers of passenger and commercial vehicles. This helps warn the driver of potentially hazardous roadway scenarios and controls certain autonomous vehicle functions.

For example, on challenging terrain with limited sight distance, warning of a hidden intersection without a traffic signal resulting from a control signal produced by at step 704 of process 700 would allow a driver to tailor speed in anticipation of vehicles entering the roadway. Intersections may not be an attribute in the map database of the driver assistance system. Accordingly, step 704 may calculate the angles between the road segments, such as the road segments shown between various nodes in FIG. 4, that are connected to the intersection node point, such as node 420 or 422, for example. The angle can be calculated from the segment node points. From the relative angles values, the intersection type and geometry can be calculated. Furthermore, on busy urban streets, where a driver's attention is focused on merging vehicles, warning of an approaching traffic signal resulting from a control signal produced by at step 706 of process 700 would redirect focus in anticipation of the signal changing or opposing traffic tuning in-path. According to one embodiment, step 706 checks two thresholds including vehicle density on the future most probable path and a distance threshold between the vehicle and a traffic signal. In addition, a warning of a railroad crossing resulting from a control signal produced by at step 708 of process 700 allows commercial vehicles to comply with hazardous material laws by timely entering the right lane and making a complete stop. Furthermore, a warning of school zones and pedestrian cross walks resulting from a control signal produced by at step 706 of process 700 allows increased driver alertness to the edge of the roadway for lateral incursions.

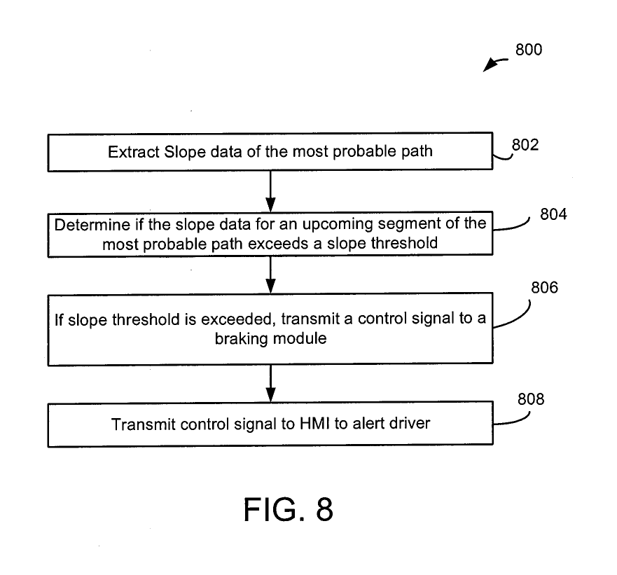

With respect to FIG. 8, process 800 provides advance knowledge of roadway and terrain variations that may also be beneficial for autonomous vehicle functions. According to one embodiment, slope data for the most probable path determined at step 608 of process 600 as shown in FIG. 6 is retrieved from the map database 208 at various nodes 506, 508, 510, and 512 along the most probable path 500 at step 802. At step 804, the slope for a future segment predicted to be encountered by vehicle 514 is compared with a slope threshold. According to one embodiment there is one slope threshold magnitude for positive and negative slopes. According to another embodiment, there are separate thresholds for positive and negative slopes. According to a another embodiment, the slope threshold is variable and depends on input factors such as vehicle location data or vehicle sensor input data. At step 806, if the slope threshold is exceeded, a control signal is transmitted to a vehicle module such as a braking module and/or is used to produce a warning at an HMI at step 808. For example, knowledge of extended downhill slopes allows hybrid vehicles to utilize regenerative braking to reenergize battery capacity. Advance knowledge of problematic intersections (hidden intersections or high incidence of accidents) allows vehicles to pre-prime braking pressure in silent anticipation of cross-traffic collision.

In one exemplary embodiment, the map system, vision system, and GPS device of the driver assistance system can be used together to advise the driver regarding lane changes in order to minimize braking. The driver assistance system 220 may provide the driver with lane change advice while nearing an exit ramp so that the vehicle has a smooth transition from high to low speed with minimal braking. The lane change advice may be shown in an HMI display and be determined by an exit ramp algorithm stored in warning determination module 214. One exemplary embodiment of the exit ramp algorithm is shown as process 900 in FIG. 9.

At step 902 of process 900, the exit ramp algorithm determines if an exit ramp exists on the future most probable path, based data retrieved from map database 208, for example. At steps 904 and 906, the current lane the vehicle is located in and the number of other vehicles on the road in the front and/or rear of the vehicle can be obtained from the vision system (or radar sensors if available). At step 908, the speed of the vehicle can be retrieved from vehicle sensor 204, for example, or from GPS unit 202. By combining the calculated vehicle position with the digital map system, the driver assistance system may calculate a distance to the upcoming branch connected to the exit ramp in module 326 at step 910. Based on the inputs received and calculations determined in steps 902, 904, 906, 908, and 910, an algorithm including one or more threshold values such as a speed threshold, lane proximity threshold, distance threshold, and traffic threshold may output a control signal if one or more of the threshold values is exceeded at steps 912 and 914.

Accordingly, the driver assistance system may use data from the digital map system, vision system and GPS device to generate and execute an algorithm to provide lane change recommendations and vehicle speed profiles to the driver. The driver assistance system may also generate and execute a control algorithm for controlling the vehicle speed and steering angle.

In another exemplary embodiment, the map system, vision system, and GPS device of the driver assistance system can be used together to provide a control signal at step 914 of process 900 containing data to cause optimal deceleration on an exit ramp. The lane change algorithm may be modified to advise the driver of optimal deceleration while approaching the ramp based on the vehicle current speed and the ramp curvature. The driver assistance system may calculate the ramp curvature profile from the shape points of the ramp in the digital map database. A control algorithm may also be used to control the vehicle speed and steering angle by transmitting control signals to at least one of a steering wheel control module 116 and an engine control module 122 without human intervention.

The driver assistance system 220 may use the on-board vision/radar system and GPS device with vehicle parameters. The driver assistance system may also combine digital map data to get lane information, speed limit information, curvature information, and ramp attributes during process 900.

The driver assistance system 220 may assist in improving gas mileage of the vehicle and aid in reducing gas consumption. The driver assistance system may assist in optimal braking to increase the life of brakes/vehicle by providing the control signal from step 914 to eco-optimization module 234, for example. The driver assistance system may assist in avoiding last minute exit situations and thus reduce risk while driving. The driver assistance system may provide optional speed information based on the vehicle parameters and road environment. The driver assistance system may assist in driver training for an optimal driving style. The driver assistance system may assist in reducing insurance costs.

The present disclosure has been described with reference to example embodiments, however persons skilled in the art will recognize that changes may be made in form and detail without departing from the spirit and scope of the disclosed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the exemplary embodiments is manifestly intended to be as broad as possible. For example, unless specifically otherwise noted, the exemplary embodiments reciting a single particular element also encompass a plurality of such particular elements.

Exemplary embodiments may include program products comprising computer or machine-readable media for carrying or having machine-executable instructions or data structures stored thereon. For example, the driver monitoring system may be computer driven. Exemplary embodiments illustrated in the methods of the figures may be controlled by program products comprising computer or machine-readable media for carrying or having machine-executable instructions or data structures stored thereon. Such computer or machine-readable media can be any available media which can be accessed by a general purpose or special purpose computer or other machine with a processor. By way of example, such computer or machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of computer or machine-readable media. Computer or machine-executable instructions comprise, for example, instructions and data which cause a general purpose computer, special purpose computer, or special purpose processing machines to perform a certain function or group of functions. Software implementations of the present invention could be accomplished with standard programming techniques with rule based logic and other logic to accomplish the various connection steps, processing steps, comparison steps and decision steps.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

What is claimed is:

1. A driver assistance system for providing driver and vehicle feedback control signals comprising:
a map database comprising navigation characteristics related to road locations;
a GPS unit that receives location data of the vehicle;
a map matching module configured to receive the location data of the vehicle and retrieve navigation characteristics relevant to the location data using a processing circuit;
a prediction module configured to generate a most probable future path for the vehicle and to determine a location of at least one navigation characteristic with respect to the most probable future path and the vehicle;
at least one vehicle sensor unit configured to generate vehicle data; and
a warning module configured to transmit a control signal to a vehicle control area network to warn the driver of an upcoming navigation characteristic on the most probable path.

2. The driver assistance system of claim 1, wherein the at least one navigation characteristic comprises an exit ramp, the generated vehicle data comprises lane recognition data, and
the warning module transmits the control signal to a human machine interface based on the location of the exit ramp on the most probable path and the lane recognition data.

3. The driver assistance system of claim 2, wherein the at least one navigation characteristic further comprises ramp curvature data, the generated vehicle data further comprises vehicle speed data, and the control signal comprises data used to advise the driver of optimal deceleration at the human machine interface.

4. The driver assistance system of claim 1, wherein the at least one navigation characteristic comprises an exit ramp, the generated vehicle data comprises lane recognition data, and
the warning module transmits the control signal to at least one of a engine control module and a steering wheel module to control vehicle speed or vehicle steering without human intervention.

5. The driver assistance system of claim 1, wherein the at least one navigation characteristic comprises an intersection without a traffic signal, the generated vehicle data comprises vehicle speed data, and the warning module transmits the control signal to a human machine interface based on the location of the intersection on the most probable path and the vehicle speed.

6. The driver assistance system of claim 1, further comprising the prediction model further configured to calculate the angles of intersection between the future most probable path and intersecting pathways and wherein the generated vehicle data comprises vehicle speed data, and the warning module transmits the control signal to a human machine interface based on the angles of intersection on the most probable path and the vehicle speed.

7. The driver assistance system of claim 1, wherein the warning module transmits the control signal to at least one of a engine control module and a steering wheel module to control vehicle speed or vehicle steering without human intervention.

8. The driver assistance system of claim 1, wherein the at least one navigation characteristic comprises the slope of the future most probable path, the generated vehicle data comprises vehicle speed data, and the warning module transmits the control signal to at least one of a engine control module and braking module to control vehicle speed or vehicle braking without human intervention.

9. The driver assistance system of claim 8, further comprising transmitting the control signal to an eco-optimization module that further communicates with the engine control module and the braking control module to improve at least one of vehicle battery capacity and vehicle fuel efficiency.

10. The driver assistance system of claim 2, wherein the human machine interface comprises at least one of an audible indicator, a visual indictor, and a tactile indicator.

11. A method of assisting a driver of a vehicle by providing driver and vehicle feedback control signals, the method comprising:
receiving location data of the vehicle from a GPS unit;
receiving the location data of the vehicle and retrieving navigation characteristics relevant to the location data using a processing circuit;
generating a most probable future path for the vehicle and determining a location of at least one navigation characteristic with respect to the most probable future path and the vehicle;
generating vehicle data at least one vehicle sensor; and
transmitting a control signal to a vehicle control area network to warn the driver of an upcoming navigation characteristic on the most probable path.

12. The method of claim 11, wherein the at least one navigation characteristic comprises an exit ramp, the generated vehicle data comprises lane recognition data, and the warning module transmits the control signal to a human machine interface based on the location of the exit ramp on the most probable path and the lane recognition data.

13. The method of claim 12, wherein the at least one navigation characteristic further comprises ramp curvature data, the generated vehicle data further comprises vehicle speed data, and the control signal comprises data used to advise the driver of optimal deceleration at the human machine interface.

14. The method of claim 11, wherein the at least one navigation characteristic comprises an exit ramp, the generated vehicle data comprises lane recognition data, and the warning module transmits the control signal to at least one of a engine control module and a steering wheel module to control vehicle speed or vehicle steering without human intervention.

15. The method of claim 11, wherein the at least one navigation characteristic comprises an intersection without a traffic signal, the generated vehicle data comprises vehicle speed data, and the warning module transmits the control signal to a human machine interface based on the location of the intersection on the most probable path and the vehicle speed.

16. The method of claim 11, further comprising the prediction model further configured to calculate the angles of intersection between the future most probable path and intersecting pathways and wherein the generated vehicle data comprises vehicle speed data, and the warning module transmits the control signal to a human machine interface based on the angles of intersection on the most probable path and the vehicle speed.

17. The method of claim 11, wherein the warning module transmits the control signal to at least one of a engine control module and a steering wheel module to control vehicle speed or vehicle steering without human intervention.

18. The method of claim 11, wherein the at least one navigation characteristic comprises the slope of the future most probable path, the generated vehicle data comprises vehicle speed data, and the warning module transmits the control signal to at least one of a engine control module and braking module to control vehicle speed or vehicle braking without human intervention.

19. The method of claim 18, further comprising transmitting the control signal to an eco-optimization module that further communicates with the engine control module and the braking control module to improve at least one of vehicle battery capacity and vehicle fuel efficiency.

20. The method of claim 12, wherein the human machine interface comprises at least one of an audible indicator, a visual indictor, and a tactile indicator.
